(19) United States
(12) Patent Application Publication
(10) Pub. No.: US 2020/0210612 A1
(43) Pub. Date: Jul. 2, 2020

(54) POLICY BASED LIFECYCLE MANAGEMENT OF PERSONAL INFORMATION

(71) Applicant: International Business Machines Corporation, Armonk, NY (US)

(72) Inventors: Celso de Almeida Saad, Sao Paulo (BR); Cassandro Jose da Paz Pereira, Sao Paulo (BR); Joao Paulo Karol Santos Nunes, Sao Paulo (BR); Jose Maria Cesario, JR., Sao Paulo (BR)

(21) Appl. No.: 16/237,936

(22) Filed: Jan. 2, 2019

(51) Int. Cl. G06F 21/62; G06F 3/06

(52) U.S. Cl. CPC G06F 21/6245; G06F 3/067; G06F 3/0605; G06F 3/0649

(57) ABSTRACT

Disclosed is a method for managing the lifecycle of personal information. The method comprises initializing by a personal information manager, a controller database, wherein the controller database serves as a privacy service contract between a data subject, a data controller, and at least one data processor, wherein initializing the controller database further comprises defining a plurality of events, and wherein the personal information manager operates the data controller. The method also includes storing a plurality of personal information from the data subject, registering the at least one data processor to perform a first event of the plurality of events, receiving an event request to perform the first event, validating, in response to receiving the event request, the at least one data processor by verifying the data subject provided consent to perform the first event, and performing, in response to validating the at least one data processor, the first event.

### BACKGROUND

The present disclosure relates to data management, and, more specifically, to managing personal information of data subjects.

Information privacy (e.g., data privacy or data protection) is the relationship between the collection and dissemination of data, the technology used to collect and disseminate data, the public's expectation of privacy of the data, and the legal and political issues that dictate what is considered to be private data. Privacy concerns arise whenever personal identifiable information or other sensitive information is collected, stored, used, or otherwise disseminated.

### SUMMARY

Disclosed is a computer-implemented method for managing the lifecycle of personal information. The method comprises initializing by a personal information manager, a controller database, wherein the controller database serves as a privacy service contract between a data subject, a data controller, and at least one data processor, wherein initializing the controller database further comprises defining a plurality of events wherein the personal information manager operates the data controller. The method also includes storing a plurality of personal information from the data subject. The method further comprises registering the at least one data processor to perform a first event of the plurality of events. The method further includes receiving an event request to perform the first event. The method also includes validating, in response to receiving the event request, the at least one data processor by verifying the data subject provided consent to perform the first event. The method also includes performing, in response to validating the at least one data processor, the first event. A system and computer program product to carry out the above method is also disclosed.

The present Summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of a computing environment suitable for operation of a personal information manager, in accordance with various embodiments of the present disclosure.

FIG. 2 is a block diagram depicting communication channels for operation of a personal information manager, in accordance with various embodiments of the present disclosure.

FIG. 3 is a flowchart depicting an example method for managing personal information, in accordance with various embodiments of the present disclosure.

FIG. 4 is a flowchart depicting deleting data requested by a data subject, in accordance with various embodiments of the present disclosure

FIG. 5 is a flowchart depicting retrieving data uses, in accordance with various embodiments of the present disclosure.

FIG. 6 is a flowchart depicting deleting data based on a retention period, in accordance with various embodiments of the present disclosure.

FIG. 7 illustrates a block diagram of an example personal information manager, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward data management, and, more specifically, to managing the personal identifiable information of a data subject. While not limited to such applications, aspects of the present disclosure may be better appreciated in light of the aforementioned applications.

Information privacy (e.g., data privacy or data protection) is the relationship between the collection and dissemination of data, the technology used to collect and disseminate data, the public's expectation of privacy of the data, and the legal and political issues that dictate what is considered to be private data. Privacy concerns arise whenever personally identifiable information or other sensitive information is collected, stored, used, or otherwise disseminated.

Many new and developing technologies require users to share their personal information to adequately utilize the offered services. For example, online shopping can ask a user to provide a shipping address for purchased goods. In some cases, the company that first collects the personal information transfers the data to third parties to assist efficient completion of a task. For example, a bank may send data about a customer to a third party to request a credit score of the customer. Other technologies are provided free of cost in exchange for use of personal information. For example, a social network can use information entered into a profile to direct relevant advertisements to the data subject.

The amount of personal data that is used and shared by these technologies is rapidly increasing. The rapid increase has led to new concerns relating to the protection of privacy and the prevention of misuse of the personal information of technology users. New policies and laws have been written to assist consumers in protecting their personal data. One such new law is the General Data Protection Regulation (GDPR) enacted by the European Union. Additionally, companies that collect and use data create internal policies for how to manage and use data subject's personal information. These policies can have rules relating to the use and storage of a data subject's personal information. The policy can control how data is used, if and with whom it can be shared, when and how it should be deleted, and so on.

Embodiments of the present disclosure provide a method of managing the lifecycle of a user's personal information. In some embodiments, the data lifecycle is managed through web services and/or Application Programming Interfaces (“API”) in communication with the personal information database and back end services of the data collector. Embodiments of the present disclosure can provide a system to promote compliance with a privacy policy and provide consumers with an efficient method to determine which of their personal data is being used for what purposes. Additionally, embodiments to the present disclosure provide an efficient method of updating, including deleting, data from any entity with which personal information was given and any third party with which the data was shared.

For purposes of this disclosure the term “data subject” can mean any natural person or persons about which information may be gathered and stored. The term “personal information” can mean any information relating to a natural person who is or can be identified, directly or indirectly, by reference to an identifier such as a name, an identification number, location data, an online identifier, by one or more factors specific to the physical, physiological, genetic, mental, economic, cultural, or social identity of that person, and/or other identification data. The terms personal information and personal data may be used interchangeably. The term “data controller” can mean the party or entity that alone, or jointly with others, determines the purposes and means of the processing and use of the personal information.

For purposes of this disclosure the term “data processor” can mean the party or entity which processes personal data on behalf of, and based on, instructions of the data controller. The term “data handler” can mean either data controller, data processor, or both. The terms “event” or “data event” can represent any instance personal information is used by a data controller or data processor for a task. Events can be data subject initiated, data controller initiated, data processor initiated, or automatically initiated. Examples of data subject-initiated events can include adding data to a database, removing data from a database, querying data in a database, requesting which data processors have access to a data subject's personal information, and other similar events. Examples of data controller-initiated events can include sending data to one or more data processors, notifying data subjects of changes in policies, using the data to complete a task or service, and other similar events. Examples of data processor-initiated events can be using the data to complete a task or service, and other similar events.

For purposes of this disclosure the term “consent” can mean any freely given, specific, informed, and unambiguous indication, either by a statement or by a clear affirmative action, by which the data subject signifies agreement to personal data being processed. In other words, the data subject is clearly informed about the types of personal information that is collected and how that personal information is used/handled as part of their consent. The term “web service(s)” can mean a service offered by an electronic device (e.g. a smart phone) to another electronic device, communicating with each other via the World Wide Web or other network. Embodiments of the present disclosure allow multiple methods of communication between data handlers to facilitate the various data storage and transfer requirements imposed by one or more privacy policies. In a web service the web technology such as Hypertext Transfer Protocol (HTTP)—originally designed for human-to-machine communication—is utilized for machine-to-machine communication, more specifically for transferring machine-readable file formats such as Extensible Markup Language (XML), JavaScript Object Notation (JSON), and other similar formats.

Embodiments of the present disclosure can improve on previous lifecycle management systems by providing a central location where a data subject can manage all their personal data. In these embodiments, the personal information manager allows for improved control over data by a customer or data subject (e.g., improved usability for data subjects interested in reviewing or modifying usage of their personal information), and improved compliance with the privacy policy by the data handlers (e.g., improved accuracy and reliability in implementing privacy policies with respect to personal information). Additionally, embodiments of the present disclosure improve on previous systems by providing a centralized method to view, update, and delete a data subject's personal information in every context where it is being utilized. These embodiments allow for more expeditious processing of personal information and lower computational costs of system storage.

The aforementioned advantages are example advantages, and embodiments exist that can contain all, some, or none of the aforementioned advantages while remaining within the spirit and scope of the present disclosure.

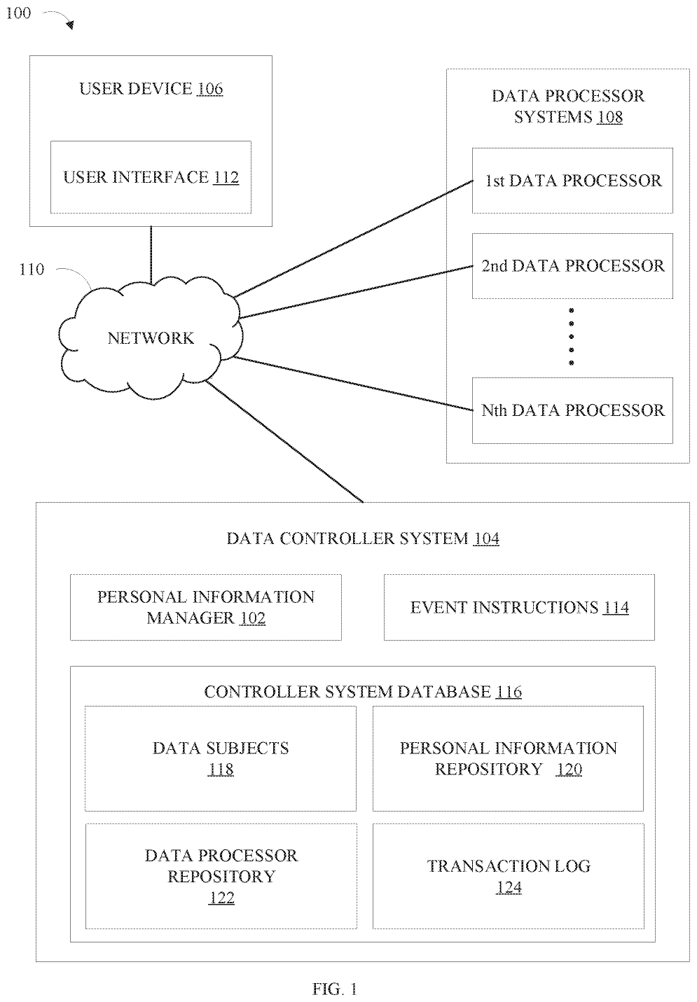

Referring now to various embodiments of the disclosure in more detail, FIG. 1 is a functional block diagram of a computing environment 100, suitable for operation of a personal information manager 102, in accordance with embodiments of the present disclosure. Many modifications to the depicted environment may be made by those skilled in the art without departing from the scope of the disclosure as recited by the claims.

Computing environment 100 includes data controller system 104, user device 106, and data processor systems 108 interconnected by network 110. Network 110 can be, for example, a telecommunications network, a local area network (LAN), a wide area network (WAN), such as the Internet, or a combination of the three, and can include wired, wireless, or fiber optic connections. Network 110 may include one or more wired and/or wireless networks that are capable of receiving and transmitting data, voice, and/or video signals, including multimedia signals that include voice, data, and video information. In general, network 110 may be any combination of connections and protocols that will support communications between data controller system 104, user device 106, and data processor systems 108, and other computing devices (not shown) within computing environment 100.

User device 106 can be a laptop computer, tablet computer, smartphone, smartwatch, or any programmable electronic device capable of communicating with various components and devices within computing environment 100, via network 110. In general, user device 106 represents any programmable electronic devices or combination of programmable electronic devices capable of executing machine readable program instructions and communicating with other computing devices (not shown) within computing environment 100 via a network, such as network 110.

User device 106 includes user interface 112. User interface 112 provides an interface between each user device 106 and data controller system 104. In some embodiments, user interface 112 may be a graphical user interface (GUI) or a web user interface (WUI) and can display text, documents, web browser windows, user options, application interfaces, API's and instructions for operation. Information presented on user interface 112 can include the information (such a graphic, text, and sound) that a program presents to a user and the control sequences the user employs to control the program. In some embodiments, user interface 112 may also be mobile application software that provides an interface between the user device 106 and data controller system 104. Mobile application software, or an “app”, is a computer program that runs on smartphones, tablet computers, smartwatches and other mobile devices.

Data controller system 104 can be any computing system such as, but not limited to, a standalone computing device, a management server, a web server, a mobile computing device, or any other electronic device or computing system capable of receiving, sending, and processing data. In some embodiments, data controller system 104 can represent a server computing system utilizing multiple computers as a server system, such as in a cloud computing environment. In an embodiment, data controller system 104 represents a computing system utilizing clustered computers and components (e.g., database server computers, application server computers, etc.) that act as a single pool of seamless resources when accessed within computing environment 100. Data controller system 104 includes personal information manager 102, event instructions 114, and controller system database 116.

Event instructions 114 can include instructions for how to perform an event. In some embodiments, each event has a distinct set of instructions. In some embodiments, the event instructions 114 include a determination as to whether the event should be added to transaction log 124.

Controller system database 116 can be a repository where data relating to the personal information of data subjects is stored. In some embodiments, controller system database 116 can be any system or device that is designed to store data in an organized fashion. It can include a magnetic hard disk drive, a solid state disk drive, a semiconductor storage device, read-only memory (ROM), electronically erasable programmable read-only memory (EEPROM), flash memory, any combination of the foregoing, or any other computer readable storage media that is capable of storing program instructions or digital information. Controller system database 116 can include data subjects 118, personal information repository 120, data processor repository 122, and transaction log 124.

In some embodiments, controller system database 116 is comprised of a single database system. In embodiments, controller system database 116 is comprised of multiple independent databases each of data subjects 118, personal information repository 120, data processor repository 122, and transaction log 124. In these embodiments, the separate database systems can be configured such that a breach of one system does not allow access to data stored in an alternate system. This can provide additional security for personal information. For example, if the information in data subject 118 is compromised, the personal information of the data subjects stored in personal information repository 120 remains private. Alternatively, if personal information repository 120 is compromised, there is no link between data in the personal information repository 120 and data subject identifiers in data subjects 118. Thus, embodiments of the present disclosure utilizing separate databases in controller system database 116 can improve data security by isolating security breaches.

In some embodiments, each of data subjects 118, personal information repository 120, data processor repository 122, and transaction log 124 can be stored in one or more data processor systems 108. In some embodiments, multiple copies of data subjects 118, personal information repository 120, data processor repository 122, and transaction log 124 can each be stored in a different data processor systems 108. In some embodiments, a portion of data subjects 118, personal information repository 120, data processor repository 122, and transaction log 124 are stored in controller system database 116 and a portion are stored in one or more data processor systems 108.

In some embodiments, controller system database 116 stores the metadata of the personal information in personal information repository 120. Metadata can be information about the personal information. For example, controller system database 116 can store what personal information is stored by what data processors without the controller system database 116 actually storing the personal information. Such embodiments improve data security (e.g., by storing the metadata rather than the data itself), and such embodiments also improve storage efficiency (e.g., by storing only the metadata instead of replicating the data itself).

Data subjects 118 can be a catalogue of all current and/or previous data subjects. In some embodiments, data subjects 118 includes data subjects that have information stored in personal information repository 120. In some embodiments, data subjects 118 includes data subjects who previously had data stored in personal information repository 120. In some embodiments, each data subject is identified by a unique identifier. The unique identifier can be used to correlate a data subject to their stored data in personal information repository 120.

Personal information repository 120 can be a storage space for personal information. In some embodiments, the type of personal information stored in personal information repository 120 can be any personal information that when linked to a data subject, can potentially allow a third party to determine the identity of the data subject. In some embodiments, examples of personal information include, but are not limited to, names, addresses, birthdays, location data, transaction history, etc.

Data processor repository 122 can be a storage space for information related to each data processor that has access to or has personal information of the data subject. In some embodiments the data stored can include the identity of the data subjects, the events the processor can perform, past data processors, the means of communication and other data relevant to managing personal information in accordance with a privacy policy. In some embodiments, the data stored in data stored in data processor repository 122 is defined by the privacy policy.

In some embodiments, controller system database 116 can include a transaction log 124. In some embodiments, the transaction log 124 records each instance of a data subject's personal information being used in any event. This can include user-initiated events or data controller initiated events. An event can include a transfer of data between parties, adding or deleting data, a request to view data, a request to see which and how many data processors have access to data, each time a piece of data is used in a process or transaction, and any other similar actions.

Data processor systems 108 can be a computer system operated by a data processor. In some embodiments, there can be a plurality of up to n data processors, each having their own system (1^{st} 2^{nd}, and Nth data processors are shown in FIG. 1, as an example). In some embodiments, the data processor systems 108 can be an entity distinct from the data controller. In some embodiments, the data processor systems 108 can be a sub group (e.g., department or affiliate) of the data controller system 104, or a sub-group of a distinct entity. In some embodiments, each entity that has access to any personal information stored in controller system database 116 can be a data processor of data processor systems 108. In some embodiments, each event type during which personal information is used is correlated to a unique data processor in data processor systems 108. An event type can be any action in which personal data is used to complete the action.

Data processor systems 108 can be any computing system such as, but not limited to, a standalone computing device, a management server, a web server, a mobile computing device, or any other electronic device or computing system capable of receiving, sending, and processing data. In other embodiments, data processor systems 108 can represent a server computing system utilizing multiple computers as a server system, such as in a cloud computing environment. In an embodiment, data processor systems 108 represents a computing system utilizing clustered computers and components (e.g., database server computers, application server computers, etc.) that act as a single pool of seamless resources when accessed within an individual data processor of the data processor systems 108.

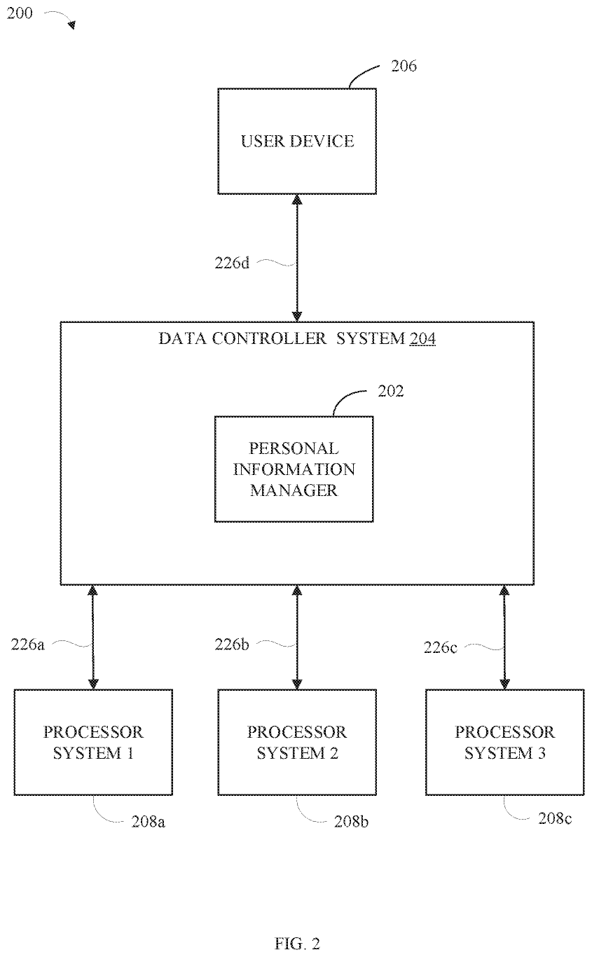

FIG. 2 depicts potential communication channels consistent with various embodiments of the present disclosure, generally labeled 200. FIG. 2 includes personal information manager 202, data controller system 204, user device 206, and processor system 1 208a, processor system 2 208b, and processor system 3 208c, or collectively processor systems 208. In some embodiments, the data controller system 204 includes (e.g., houses, is coupled to, etc.) the personal information manager 202. Personal information manager 202, data controller system 204, user device 206, and plurality of processor systems 208 can be consistent with personal information manager 102, data controller system 104, user device 106, and data processor systems 108, of FIG. 1, respectively.

FIG. 2 also includes communication channels 226a-d. In some embodiments, communication channels 226 can be configured such that data controller system 204 can communicate with the other systems shown in FIG. 2. For example, communication channel 226d can be configured to receive data from and send data to user device 206, communication channel 226a can be configured to exchange data between data controller system 204 and processor system 1 208a, and so on. In some embodiments, communication channels 226 can include one or more networks consistent with network 110 of FIG. 1. In some embodiments, communication channels 226 can include a web service. In some embodiments, communication channels 226 can include one or more Application Programming interfaces (API). An API can be a set of routines, protocols, or other tools that specify how two or more computers should interact. For purposes of this disclosure web services and API may be used interchangeably.

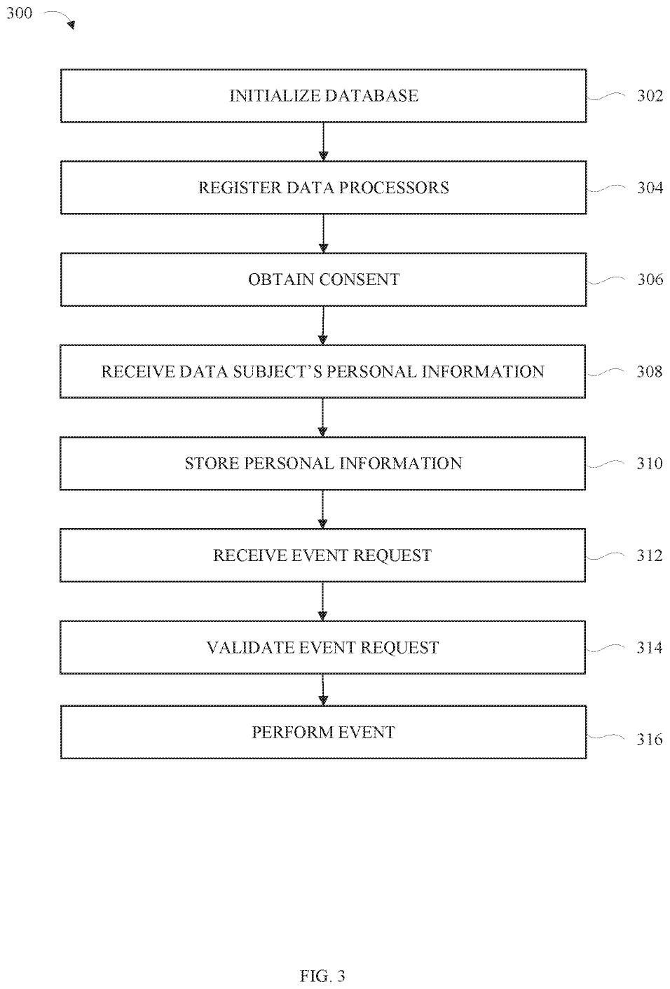

In some embodiments, communication channels 226 provide personal information manager 202 a method to transfer data to and from user device 206 and the plurality of processor systems 208 via data controller system 204. In some embodiments, the type of communication channel is determined when the database is initiated at operation 302 of FIG. 3 (discussed hereinafter). In some embodiments, the communication channels 226 are defined when registering data processors at operation 304 of FIG. 3 (discussed hereinafter).

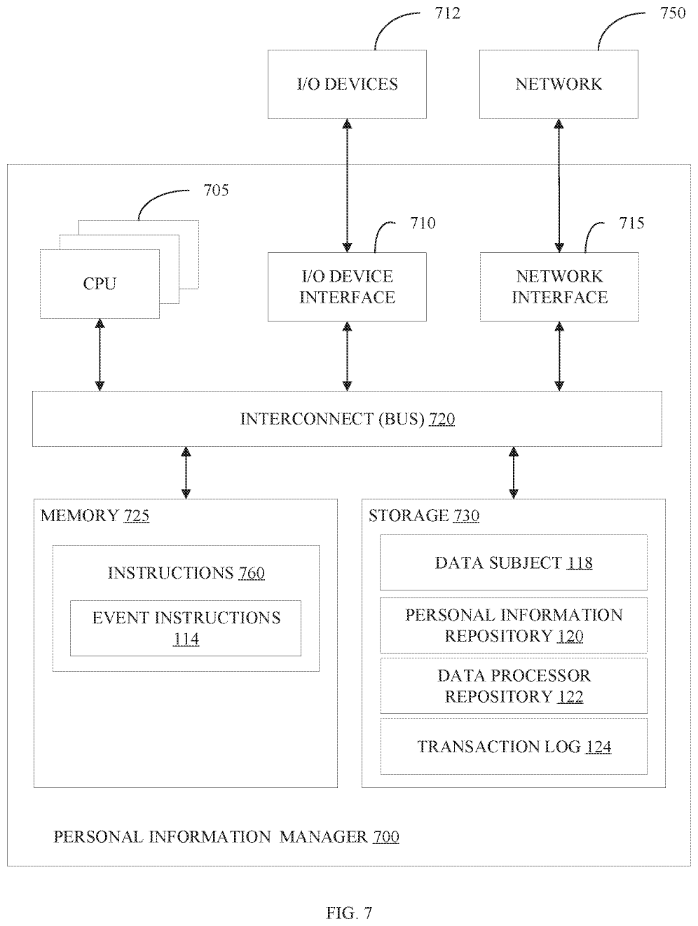

FIG. 3 depicts a flowchart of an example method 300 for managing personal information, in accordance with embodiments of the present disclosure. Method 300 can include more or fewer operations than those operations that are explicitly depicted. Method 300 can include operations in different orders than those orders depicted. Likewise, the method 300 can include operations that occur simultaneously rather than sequentially. Many modifications to the depicted method may be made by those skilled in the art without departing from the spirit and scope of the present disclosure. Method 300 can be implemented by one or more processors, personal information manager 102 of FIG. 1, data controller system 104 of FIG. 1, user device 106 of FIG. 1, personal information manager 202 of FIG. 2, data controller system 204 of FIG. 2, personal information manager 700 of FIG. 7, or a different combination of hardware and/or software. For clarity, the method 300 is described as being implemented by personal information manager 102.

At operation 302, personal information manager 102 initializes a database. In some embodiments, the database is controller system database 116. In some embodiments, initializing a database includes defining a privacy policy. In some embodiments, the privacy policy can be based on a law or regulation. In some embodiments, the privacy policy can be based on the GDPR. In some embodiments, the privacy policy can be based on a user agreement, where a user agreement is an agreement between a data subject and a party collecting data from the data subject that informs the data subject on how the information can be used.

In some embodiments, initializing the database includes defining a plurality of events. In some embodiments, the plurality of events are based on the privacy policy. For example, if the privacy policy is a law that allows a data subject to view what data an entity has stored, an event could be to provide a view of the stored data to a data subject. In some embodiments, the events can include, but are not limited to: retrieving personal information, deleting personal information, updating personal information, view who data has been shared with, view how data is being used, provide consent, revoke consent, add data processors, remove data processors, update data processors' personal information, authorize uses of personal information, and other similar events.

At operation 304, personal information manager 102 registers the data controller and/or data processors. In some embodiments, the registration acts as a privacy service contract between the data subject, the data controller, and the data processors. The privacy service contract can be an agreement between the parties involved that the personal information will be handled in accordance with the privacy policy, and that all parties will strictly follow all instructions and perform all events as requested. In some embodiments, registration is when the data handler agrees to comply with the privacy policy. A data handler is any entity that will have access to or use personal information. In some embodiments, a data handler can be the data controller and/or the data processors.

In some embodiments, personal information manager 102 registers a data handler to perform one or more events. Said differently, a data handler can be registered separately for each event to be performed. For example, if a piece of data can be used to complete event A and event B, and the same data processor performs both of the events, then the data handler can be registered twice, once to perform event A and once to perform event B. In some embodiments, the data handlers' registrations are stored in controller system database 116. In some embodiments, the data handlers' registrations are stored in the data processor repository 122 of the data controller system 104.

At operation 306, personal information manager 102, obtains consent from the data subject to use the personal information. In some embodiments, the data subject consents to use of the personal information to complete one or more events. Obtaining consent can include receiving an electronic signature of a data subject on an agreement regarding the use of personal information.

At operation 308, personal information manager 102 receives personal information from a data subject. In some embodiments, the data subject is a person. In some embodiments, a data subject is an organization. In some embodiments, the personal information is shared with a data handler. In some embodiments, the data subject provides the personal information in exchange for using a service offered by the data handler.

In some embodiments, personal information manager 102 provides the data subject a set of operations the user can perform to the personal information. In some embodiments, an operation is equivalent to an event. In these embodiments, the operations can include: deleting personal information, updating personal information, viewing where data has been shared, viewing how data is being used, and other similar operations.

At operation 310, personal information manager 102 stores the personal information in the database. In some embodiments the personal information is encrypted. In some embodiments, the personal information is stored as metadata. In some embodiments, each piece of metadata is linked with a retention period when it is stored in the database. In some embodiments, the personal information is stored in controller system database 116. In some embodiments, the personal information is stored in personal information repository 120.

In some embodiments, personal information manager 102 determines which personal information will be used in events performed by personal information manager 102. In these embodiments, the personal information that is used locally will be stored, and the remainder will be stored as metadata. This will limit the amount of storage space required, and will limit the duplication of data thereby saving processing time. Additionally, these embodiments limit the severity of a data breach by having less data available.

At operation 312, personal information manager 102 receives an event request. In some embodiments, the event request can be initiated by the data subject, the data controller, or one of the data processors. In some embodiments, the event request is generated based on information stored in controller system database 116. In these embodiments, automatically generated event requests can be related to consent, to registration, to retention periods, and other similar information. For example, if personal data is linked with a retention period, the event request to delete the data will automatically be generated by personal information manager 102 at the expiration of the retention period.

At operation 314, personal information manager 102 validates the event request. In some embodiments, the validation is based on verifying compliance with the privacy policy. In these embodiments, the event request is denied or not performed when it would cause a violation of the privacy policy. For example, assume the privacy policy prohibits the transfer of data across an international boundary. Event request A includes transferring a set of data from country A to country B. Personal information manager 102 would deny the request and not transfer the data. In some embodiments, when the event is successfully validated it can be considered a positive validation.

In some embodiments, the validation occurs when personal information manager 102 determines appropriate consent has been obtained from the data subject to perform the event. For example, if the event includes transferring data to data processor A, validation could include one or more of checking the data subject has consented to the sharing of data, checking the data subject consented to sharing data with data processor A, ensuring the data subject can see which data processors have certain data, etc.

In some embodiments, the validation occurs when the personal information manager 102 determines the data handlers involved have been registered to perform the requested event. In these embodiments, if personal information manager 102 determines the registration has not occurred, was not complete, or is otherwise invalid (e.g., expired) the event request is denied, or the event is not performed.

At operation 316, personal information manager 102 performs the requested event. In some embodiments, the event is performed by a web service. In some embodiments, the event is performed by sending, to a data handler, instructions to complete an event. For example, if the event is to “delete data A” and that data has been shared with one or more data processors, personal information manager 102 will send the instructions of “delete data A” to the data processor. In some embodiments, the event can be considered performed (or completed) at the time the instructions are sent to the data handler. In some embodiments, the event is considered complete after the data handler responds to receiving the instructions. In these embodiments the response can be acknowledging receipt, or the response can be a notification the instructions have been completed.

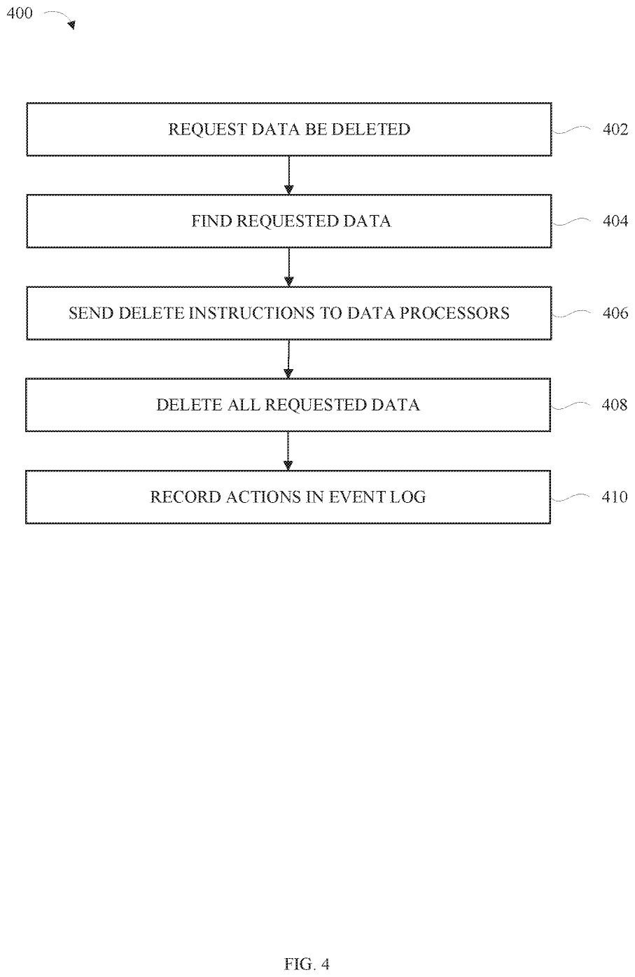

In some embodiments, performing the event includes the data subject, the data controller, and the data processor as discussed with respect to FIG. 4. Referring now to FIG. 4, illustrated is a flowchart of an example method 400, for a data subject requesting all data be deleted, consistent with various embodiments of the present disclosure. This example is one of many events that involve sending instructions to one or more data processors. Method 400 is depicted as being performed by personal information manager 102, however in some embodiments, method 400 can be performed by data controller system 104 and/or controller system database 116 of FIG. 1, data controller system 204 and/or personal information manager 202 of FIG. 2, and/or personal information manager 700 of FIG. 7.

At operation 402, personal information manager 102 receives a request from a data subject to delete all data. At operation 404, personal information manager 102 searches controller system database 116 to identify all locations where the data subject's personal information is being stored and which data processors have the personal information. For example, assume a data subject requested to see which data processors have access to the data subject's telephone number. Personal information manager 102 can check transaction log 124 for each instance of sending the data subject's phone number to any processors. Next, personal information manager 102 can determine what events those data processors are registered to perform, specifically which events involve storing the telephone number. Then personal information manager 102 can send the data comprising which data processors have had access to the telephone number, and which data processors have stored the telephone number.

At operation 406, personal information manager 102 sends instructions to the relevant data processors to delete all of the data subject's personal information. At operation 408, personal information manager 102 deletes all of the data subject's personal information stored in controller system database 116. At operation 410, personal information manager 102 records all actions taken in transaction log 124.

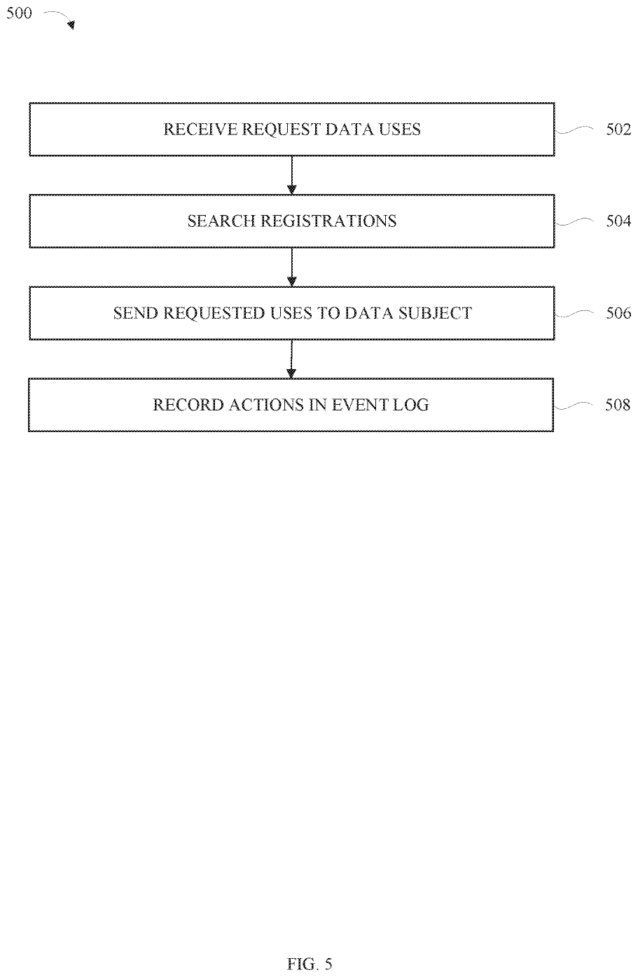

In some embodiments, performing the event includes the data subject and the data controller as discussed with respect to FIG. 5. Turning now to FIG. 5, illustrated is a flowchart of an example method 500 for a data subject requesting to view how their personal information is being used, consistent with various embodiments of the present disclosure. This example is one of many events that can involve finding information stored in controller system database 116. Method 500 is depicted as being performed by personal information manager 102, however in some embodiments, method 500 can be performed by data controller system 104 and/or controller system database 116 of FIG. 1, data controller system 204 and/or personal information manager 202 of FIG. 2, and/or personal information manager 700 of FIG. 7.

At operation 502, personal information manager 102 receives the data subject request to view how the personal information is being used. At operation 504, personal information manager 102 searches controller system database 116 for the requested information. In some embodiments, the uses are correlated with the registrations. In some embodiments, the uses are correlated with the validations. In some embodiments, the uses are correlated with data processors. At operation 506, personal information manager 102 sends the uses to the data subject. At operation 508, personal information manager 102 records each action in transaction log 124. In some embodiments, each transaction can include a search of a database, the request, the action of sending the data, and other similar actions.

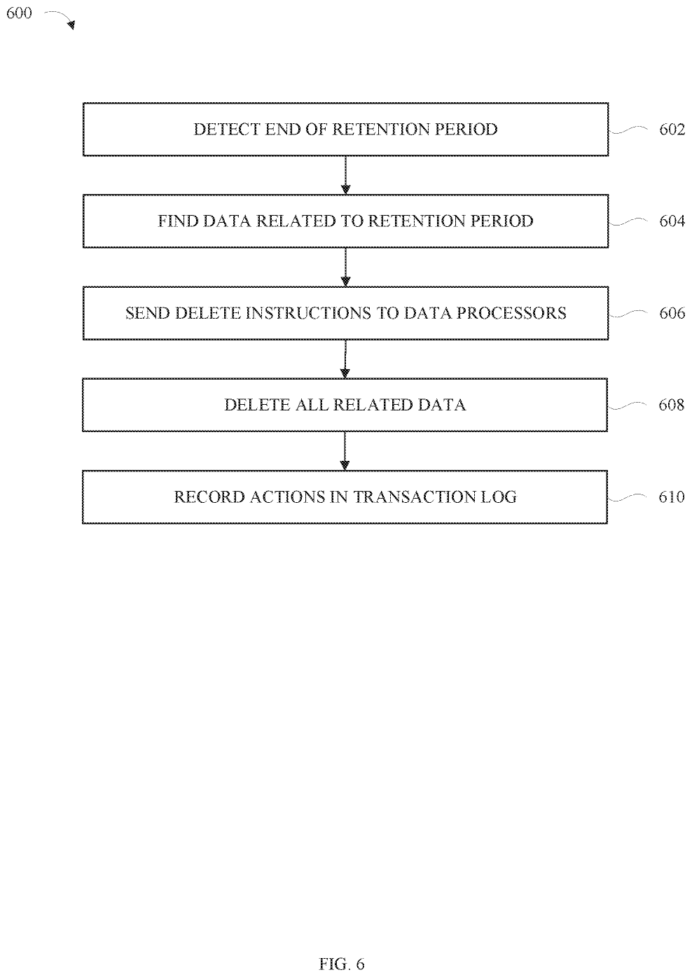

In some embodiments, performing the event includes the data controller and the data processor as discussed with respect to FIG. 6. FIG. 6 illustrates a flowchart of an example method 600 that depicts the sequence of actions when a retention period ends, consistent with various embodiments of the present disclosure. This example is one of many events that can be automatically initiated. Method 600 is depicted as being performed by personal information manager 102, however in some embodiments, method 600 can be performed by data controller system 104 and/or controller system database 116 of FIG. 1, data controller system 202 and/or personal information manager 202 of FIG. 2, and/or personal information manager 700 of FIG. 7.

At operation 602, personal information manager 102 detects the end of a retention period. At operation 604, personal information manager 102 searches controller system database 116 for personal information corresponding to the ended retention period. At operation 606, personal information manager 102 sends “delete personal information” instructions to the relevant data processors. At operation 608, personal information manager 102 deletes all the relevant personal data stored in controller system database 116. At operation 610, personal information manager 102 records all action in transaction log 124. In some embodiments, one event is a request to see the contents of the transaction log 124. This allows a user to see which data processors have used which personal data for which purposes. It also allows for a data subject to determine if the personal data is being misused (e.g., used for a purpose outside the scope of consent, used by a data processor that has not properly registered, etc.).

In some embodiments, personal information manager 102 logs each action. The actions can include, registering/unregistering data processors, data subjects sharing data, storing a piece of data, deleting a piece of data, obtaining consent, having consent revoked, receiving event requests, denying event requests, validations, failed validations, events performed, and the like.

FIG. 7 illustrates a block diagram of an example personal information manager 700, in accordance with some embodiments of the present disclosure. It is noted that the personal information manager 700 can be substantially similar to the personal information manager 102 of FIG. 1. In this disclosure personal information manager 102 and personal information manager 700 can be used interchangeably. In various embodiments personal information manager 700 can operate the systems 100, and 200 of FIGS. 1-2 and perform the methods 300, 400, 500, and/or 600 as described in FIGS. 3-6. In some embodiments, personal information manager 700 provides instructions for operating the systems 100 and 200 of FIGS. 1-2, and any of the methods 300, 400, 500, and/or 600 of FIGS. 3-6 to a client machine such that the client machine executes the method, or a portion of the method, based on the instructions provided by the personal information manager 700.

The personal information manager 700 includes a memory 725, storage 730, an interconnect (e.g., BUS) 720, one or more CPUs 705 (also referred to as processors 705 herein), an I/O device interface 710, I/O devices 712, and a network interface 715.

Each CPU 705 retrieves and executes programming instructions stored in the memory 725 or storage 730. The interconnect 720 is used to move data, such as programming instructions, between the CPUs 705, I/O device interface 710, storage 730, network interface 715, and memory 725. The interconnect 720 can be implemented using one or more busses. The CPUs 705 can be a single CPU, multiple CPUs, or a single CPU having multiple processing cores in various embodiments. In some embodiments, a CPU 705 can be a digital signal processor (DSP). In some embodiments, CPU 705 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP CPU configurations). Memory 725 is generally included to be representative of a non-volatile memory, such as a hard disk drive, solid state device (SSD), removable memory cards, optical storage, or flash memory devices. In an alternative embodiment, the storage 730 can be replaced by storage area-network (SAN) devices, the cloud, or other devices connected to the personal information manager 700 via the I/O device interface 710 or a network 750 via the network interface 715.

In some embodiments, the memory 725 stores instructions 760 (including event instructions 114) and the storage 730 stores data subjects 118, personal information repository 120, data processor repository 122, and transaction log 124. However, in various embodiments, the instructions 760, data subjects 118, personal information repository 120, data processor repository 122, and transaction log 124 are stored partially in memory 725 and partially in storage 730, or they are stored entirely in memory 725 or entirely in storage 730, or they are accessed over a network 750 via the network interface 715. Data subjects 118, personal information repository 120, data processor repository 122, transaction log 124, and event instructions 114 are as previously disclosed.

Instructions 760 can be processor-executable instructions for performing any portion of, or all of, any of the methods 300, 400, 500, and/or 600 of FIGS. 3-6.

In various embodiments, the I/O devices 712 include an interface capable of presenting information and receiving input. For example, I/O device 712 can present information to a user interacting with personal information manager 700 and receive input from the user.

Personal information manager 700 is connected to the network 750 via the network interface 715. Network 750 can comprise a physical, wireless, cellular, or different network.

Embodiments of the present disclosure can be a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instruction can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instruction can also be stored in a computer readable storage medium that can direct a computer, a programmable data processing apparatus, and/or other devices to function in a particular manner, such that the computer readable storage medium having instructions stored therein comprises an article of manufacture including instructions which implement aspect of the function/act specified in the flowchart and/or block diagram block or blocks.

The computer readable program instruction can also be loaded onto a computer, other programmable data processing apparatus, or other device to cause a series of operations steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 760 of FIG. 7 and/or any software configured to perform any subset of the methods described with respect to FIGS. 1-6) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present disclosure can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

1-8. (canceled)

9. A system comprising:
a processor; and
a computer-readable storage medium communicatively coupled to the processor and storing program instructions which, when executed by the processor, are configured to cause the processor to perform operations comprising:
initializing, by a personal information manager, a controller database, wherein the controller database serves as a privacy service contract between a data subject, a data controller, and at least one data processor, wherein initializing the controller database further comprises defining a plurality of events, and wherein the personal information manager operates the data controller;
storing, by the personal information manager, in the controller database, a plurality of personal information from the data subject;
registering, by the personal information manager, the at least one data processor to perform a first event of the plurality of events;
receiving, by the personal information manager, an event request to perform the first event;
validating, in response to receiving the event request, the at least one data processor by verifying the data subject provided consent to perform the first event; and
performing, by the personal information manager, in response to validating the at least one data processor, the first event.

10. The system of claim 9, wherein the plurality of personal information comprises a retention period, wherein the retention period is a predetermined amount of time in which the plurality of personal information will be stored, wherein the program instructions are further configured to cause the processor to perform operations further comprising:
determining, by the personal information manager, the retention period has expired; and
in response to determining the retention period has expired, sending, by the personal information manager and to the at least one data processor, instructions to delete the plurality of personal information.

11. The system of claim 9, wherein defining the plurality of events is based on a privacy policy.

12. The system of claim 11, wherein the registering comprises a web service for the at least one data processor configured to comply with the privacy policy.

13. The system of claim 9, wherein the event request is received from the data subject, and the program instructions are further configured to cause the processor to perform the operations further comprising notifying the data subject the event is complete.

14. The system of claim 9, wherein the program instructions are further configured to cause the processor to perform operations further comprising:
logging, by the personal information manager and in a transaction log in the controller database, the receiving the plurality of personal information, the registering the at least one data processor, the receiving the event request, the validating the at least one data processor, and the performing the event.

15. A computer program product, the computer program product comprising a computer readable storage medium having program instructions embodied therewith, the program instructions executable by a processing unit to cause the processing unit to perform a method comprising:
initializing, by a personal information manager, a controller database, wherein the controller database serves as a privacy service contract between a data subject, a data controller, and at least one data processor, wherein initializing the controller database further comprises defining a plurality of events, and wherein the personal information manager operates the data controller;
storing, by the personal information manager, in the controller database, a plurality of personal information from the data subject;
registering, by the personal information manager, the at least one data processor to perform a first event of the plurality of events;
receiving, by the personal information manager, an event request to perform the first event;
validating, in response to receiving the event request, the at least one data processor by verifying the data subject provided consent to perform the first event; and
performing, by the personal information manager, in response to validating the at least one data processor, the first event.

16. The computer program product of claim 15, wherein the plurality of personal information comprises a retention period, wherein the retention period is a predetermined amount of time in which the plurality of personal information will be stored, and wherein the program instructions are further configured to cause the processing unit to perform a method further comprising:
determining, by the personal information manager, the retention period has expired; and
in response to determining the retention period has expired, sending, by the personal information manager and to the at least one data processor, instructions to delete the plurality of personal information.

17. The computer program product of claim 15, wherein defining the plurality of events is based on a privacy policy.

18. The computer program product of claim 17, wherein the registering comprises a web service for the at least one data processor configured to comply with the privacy policy.

19. The computer program product of claim 15, wherein the event request is received from the data subject, and wherein the program instructions are further configured to cause the processing unit to perform a method further comprising:
notifying the data subject the event is complete.

20. The computer program product of claim 15, wherein the program instructions are further configured to cause the processing unit to perform a method further comprising:
logging, by the personal information manager and to a transaction log of the controller database, the receiving the plurality of personal information, the registering the at least one data processor, the receiving the event request, the validating the at least one data processor, and the performing the event.
